(19) United States
(12) Patent Application Publication
(10) Pub. No.: US 2009/0175488 A1
(43) Pub. Date: Jul. 9, 2009

(54) Diaphragm and Electrical-Acoustic Transducer having the same

(76) Inventor: Jui-Cheng CHANG, Taichung Industrial Park (TW)

Correspondence Address: HDLS Patent & Trademark Services, P.O. BOX 220746, CHANTILLY, VA, 20153-0746, US

(21) Appl. No.: 11/971,812

(22) Filed: Jan. 9, 2008

(51) Int. Cl. H04R 1/00

(52) U.S. Cl. 381/427

(57) ABSTRACT

An electrical-acoustic transducer includes a housing, a magnetic circuit device, a voice coil and a diaphragm. The magnetic circuit device is disposed in the housing and generates a magnetic circuit. The voice coil is disposed on the path of the magnetic circuit, and configured for generating magnetism upon receiving an electrical power. The diaphragm is made of metal, fixedly combined with the voice coil and having a scraggy cross section. When the voice coil of the electrical-acoustic transducer generates the magnetism according to the electrical power and interacts with the magnetic circuit, the diaphragm vibrates so as to generate sound.

### BACKGROUND OF THE INVENTION

1. Field of the Invention

The present invention relates to a diaphragm and an electrical-acoustic transducer having the same, and more particularly to an electrical-acoustic transducer having a diaphragm that is easy to manufacture.

2. Description of Related Art

A regular electric-acoustic transducer, for example a microphones or a speaker, usually has a diaphragm inside thereof. In the case of a microphone, the diaphragm vibrates in response to an acoustic wave so as to vary a magnetic field in the microphone and generate a corresponding electrical signal for a control device being electrically connected to the microphone to receive and operate. In the case of a speaker, the control device processes electrical signals and sends the processed electrical signals to the speaker. The magnetic field in the speaker is varied by the electric signal received by the speaker so as to vibrate the diaphragm therein and generate an acoustic wave.

Referring to FIG. 1, which is a cross-sectional view of a conventional diaphragm 10, the diaphragm 10 includes a cotton layer 11, two aluminum layers 12, and an adhesive 13 for gluing the cotton layer 11 and the two aluminum layers 12 together. The reason for choosing aluminum as the material of the layer 12 is because aluminum is easy to be formed into a thin and light layer. In addition, aluminum has a desirable appearance and yet is cost effective. Further, the aluminum is capable of generating acoustic waves of superior audio quality.

Referring to FIG. 2, which illustrates a diagram for manufacturing the conventional diaphragm 10, the adhesive 13 is first applied to a top side and a bottom side of the cotton layer 11. Then the two aluminum layers 12 are combined with the cotton layer 11 by grinding. Because the air between the different layers is squeezed out during the process of grinding, the cotton layer 11 and the aluminum layers 12 are relatively well glued.

Because the volume of the diaphragm in a microphone or a speaker is typically not very large, after the above-mentioned process, when the aluminum layers 12 and the cotton layer 11 are glued together, a cutting process is carried out only after the adhesive 13 is dried. Hence, the manufacturing of the diaphragm must involve rather complicated procedures of material preparation, gluing, grinding, drying, cutting and etc. Especially, the drying process consumes a great amount of time.

### SUMMARY OF THE INVENTION

Accordingly, it is an object of the present invention to provide a diaphragm that takes less manufacturing procedures and less time to manufacture and maintains the advantages of a conventional diaphragm containing aluminum layers.

It is another object of the present invention to provide an electrical-acoustic transducer having such diaphragm.

The attainment of these and related objects may be achieved through use of the electrical-acoustic transducer herein disclosed according to a preferred embodiment of the present invention. The electrical-acoustic transducer includes a housing, a magnetic circuit device, a voice coil and a diaphragm. The magnetic circuit device is disposed in the housing and generates a magnetic circuit. The voice coil is disposed on the path of the magnetic circuit, and configured for generating magnetism upon receiving an electrical power. The diaphragm is made of metal, fixedly combined with the voice coil and having a scraggy cross section. When the voice coil of the electrical-acoustic transducer generates the magnetism according to the electrical power and interacts with the magnetic circuit, the diaphragm vibrates so as to generate sound.

In the embodiments of the present invention, the diaphragm is manufactured directly from a metal plate, which not only eliminates the use of a cotton layer but also reduces the time and labor consuming processes such as gluing and drying. In addition, the diaphragm bears a pattern that enables the diaphragm to endure a greater stress so that such a diaphragm is more suitable to be made thin and light, which meets the trend of thinner and lighter electrical-acoustic products nowadays.

Other advantages and novel features will be drawn from the following detailed description of preferred embodiment with the attached drawings.

### BRIEF DESCRIPTION OF THE DRAWINGS

FIG. 1 is a cross-sectional view of a conventional diaphragm;

FIG. 2 illustrates a diagram for manufacturing the conventional diaphragm of FIG. 1;

FIG. 3 is a schematic view showing architecture of a diaphragm according to a preferred embodiment of the present invention;

FIG. 4 is a cross-sectional view of the diaphragm depicted in FIG. 3;

FIG. 5 illustrates a diagram for manufacturing the diaphragm depicted in FIG. 3; and

FIG. 6 is a cross-sectional view of an electrical-acoustic transducer having the diaphragm depicted in FIG. 3.

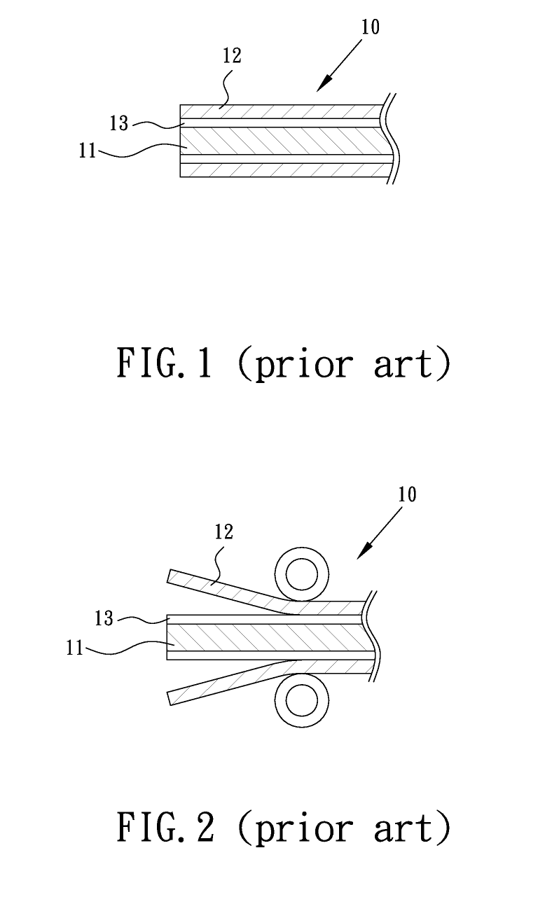

### DETAILED DESCRIPTION OF THE INVENTION

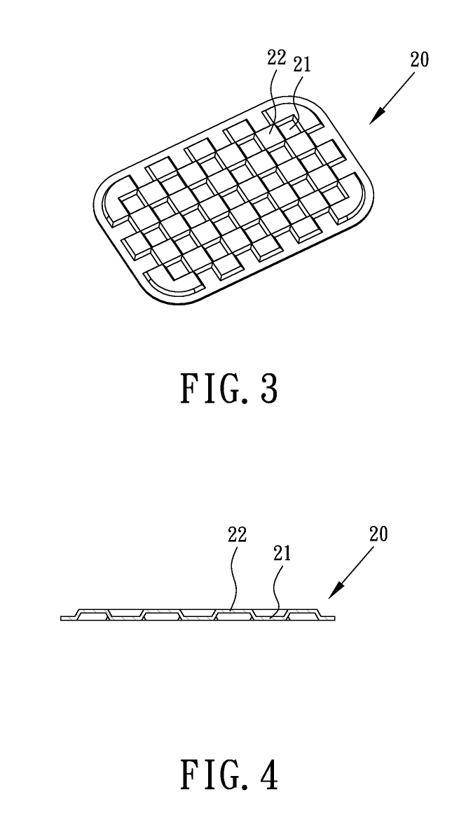

Referring to FIG. 3 and FIG. 4, a diaphragm 20 according to a preferred embodiment of the present invention is shown. The diaphragm 20 is made of metal. Preferably, the diaphragm 20 is made of aluminum. The reason for choosing is because aluminum is easy to be formed into a thin and light layer. In addition, aluminum has a desirable appearance and yet is cost effective. Further, the aluminum is capable of generating acoustic waves of superior audio quality. It is understood however that the material of the diaphragm is not limited to aluminum.

As shown in FIG. 3, the diaphragm has an essentially squared shape, on which there is a pattern including multiple concave parts 21 and multiple convex parts 22. The concave parts 21 and the convex parts 22 cross each other in a matrix arrangement, that is, each concave part 21 is surrounded by four convex parts 22 respectively, and each convex part 22 is surrounded by four concave parts 21 respectively. As shown in FIG. 4, the cross section of the diaphragm 20 is continuously scraggy, and in particular, is scraggy with a continuous trapezoid pattern.

It is understood the naming of the concave parts 21 and the naming of the convex parts 22 are interchanged if viewed by an opposite angle. In other words, the naming of the concave parts 21 and the convex parts 22 are only relative.

As for the pattern on the diaphragm 20, the concave parts 21 and the convex parts 22 can also have a domed shape, so that the diaphragm 20 has a scraggy cross section with a continuous curved pattern. Alternatively, the pattern on the diaphragm 20 can be a continuous and winding groove. In that case, the diaphragm 20 has a scraggy cross section with a continuous trapezoid or curved pattern.

By forming rough patterns on the diaphragm 20 can distribute stress rapidly during vibration. As a result, the diaphragm 20 with rough patterns thereon can handle relatively great stress. In comparison with the conventional diaphragm, the diaphragm 20 can be designed to be thinner without being possibly distorted or broken caused by vibration.

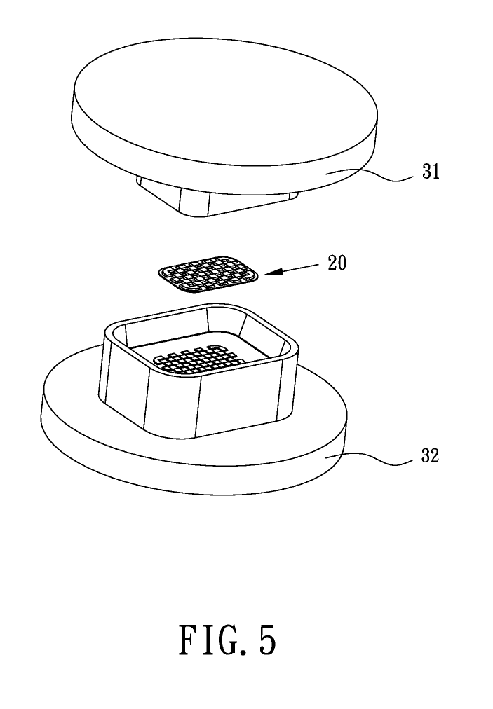

Referring to FIG. 5, in order to manufacture the diaphragm 20, a metal plate can be cut into an appropriate size first and then be put between a core 31 and a cavity 32. By pressing the core 31 and the cavity 32 the diaphragm 20 is formed.

As shown in FIG. 5, the cavity 32 has a predefined pattern therein. The pattern can be multiple concave parts and multiple convex parts crossing each other in a matrix arrangement so that the diaphragm 20 with continuous trapezoidal concave and convex parts can be formed from the metal plate by pressing. It is understood the pattern in the cavity 32 can be defined otherwise by a manufacture according to the desired pattern on the diaphragm 20 to be made. For example, the pattern in the cavity 32 can be a continuous and winding groove.

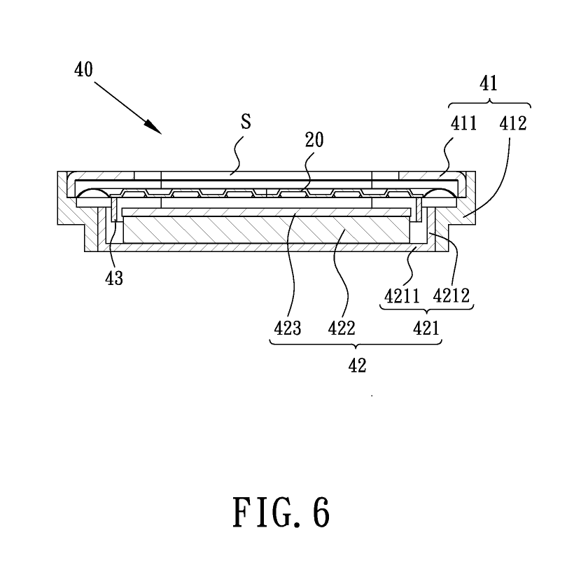

Referring to FIG. 6, an electric-acoustic transducer 40 having the diaphragm 20 according to the preferred embodiment of the present invention is shown. The electric-acoustic transducer 40 includes a housing 41, a magnetic circuit device 42 and a voice coil 43. The housing 41 includes a front lid 411 and a yoke frame 412. The front lid 411 has an opening “S”. The front lid 411 and the yoke frame 412 define a space by combination, and the defined space is configured for containing the magnetic circuit device 42, the voice coil 43 and the diaphragm 20.

The magnetic circuit device 42 includes a base 421, a magnet 422 and a pole piece 423. The base 421 includes a bottom plate 4211 and a standing part 4212, which stands from the outer edge of the bottom plate 4211 and touches the yoke frame 412. The pole piece 423 and the magnet 422 are disposed on the bottom plate 4211 respectively, and the magnet 422 and the pole piece 423 are separated from the standing part 4212 by a distance. The magnetic circuit device 42 generates a magnetic circuit going through the bottom plate 4211, the magnet 422, the pole piece 423, the distance between the pole piece 4223 and the standing part 4212, and the standing part 4212.

The voice coil 43 can be, for example, but not limited to be a copper wire curled in the space between the pole piece 423 and the standing part 4212 so as to overlap a portion of the magnetic circuit generated by the magnetic circuit device 42. The two ends of the copper wire are usually pulled out and electrically connected with a printed circuit board in the electrical-acoustic transducer 40 for receiving electric power and thereby generating magnetism.

When installed in the electrical-acoustic transducer 40, the diaphragm 20 is fixedly disposed on the voice coil 43. When receiving electric power and thereby generating magnetism, the voice coil 43 interacts with the magnetic circuit and vibrates, which drives the diaphragm 20 to vibrate so as to generate sound. The generated sound is output from the opening “S” of the front lid 411.

In the above embodiments, the diaphragm 20 is manufactured directly from a metal plate, which not only eliminates the use of a cotton layer but also reduces the time and labor consuming processes such as gluing and drying. In addition, the diaphragm 20 has a pattern formed thereon for distributing stress rapidly when vibration occurred, so that the diaphragm 20 is more suitable to be made thin and light, which meets the trend of thinner and lighter electrical-acoustic products nowadays.

While the present invention has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and illustrative examples shown and described.

What is claimed is:

1. An electrical-acoustic transducer comprising:
a housing;
a magnetic circuit device disposed in the housing for generating a magnetic circuit;
a voice coil disposed on the path of the magnetic circuit for generating magnetism upon receiving an electric power; and
a diaphragm made of metal, fixedly combined with the voice coil, having a scraggy cross section;
wherein when the voice coil generates the magnetism according to the electric power and interacts with the magnetic circuit, the diaphragm vibrates so as to generate sound.

2. The electrical-acoustic transducer as described in claim 1, wherein the diaphragm is made of aluminum.

3. The electrical-acoustic transducer as described in claim 1, wherein the diaphragm has a continuously scraggy cross section with a trapezoid pattern or a curved pattern.

4. The electrical-acoustic transducer as described in claim 1, wherein the diaphragm has a substantially squared shape and comprises a plurality of concave parts and a plurality of convex parts, the concave parts and the convex parts crossing each other in a matrix arrangement.

5. The electrical-acoustic transducer as described in claim 1, wherein the diaphragm has a substantially squared shape and comprises a continuous and winding groove.

6. The electrical-acoustic transducer as described in claim 1, wherein the diaphragm is formed from a metal plate using a core and a cavity by pressing.

7. The electrical-acoustic transducer as described in claim 6, wherein the cavity or the core has a predetermined pattern therein, the pattern being configured for forming the metal plate into the diaphragm with a continuously scraggy cross section by pressing.

8. The electrical-acoustic transducer as described in claim 1, wherein the housing comprises a front lid and a yoke frame combined with each other, the front lid having an opening for outputting sound.

9. The electrical-acoustic transducer as described in claim 8, wherein the magnetic circuit device comprises a base, a magnet and a pole piece, the base comprising a bottom plate and a standing part, which stands from the outer edge of the bottom plate and touches the yoke frame, the magnet being disposed on the bottom plate and separated from the standing part by a distance, the pole piece being disposed on the magnet and separated from the standing part by another distance.

10. The electrical-acoustic transducer as described in claim 9, wherein the voice coil is disposed between the pole piece and the standing part.

11. The electrical-acoustic transducer as described in claim 10, wherein the voice coil is a curled copper wire.

12. The electrical-acoustic transducer as described in claim 10, wherein the voice coil is electrically connected with a printed circuit board for receiving electric power.

13. A diaphragm being disposed in an electrical-acoustic transducer, the diaphragm being made by metal and having a continuously scraggy cross section.

14. The diaphragm as described in claim 13, wherein the diaphragm is made of aluminum.

15. The diaphragm as described in claim 13, wherein the diaphragm has a continuously scraggy cross section with a trapezoid pattern or a curved pattern.

16. The diaphragm as described in claim 13, wherein the diaphragm has a substantially squared shape and comprises a plurality of concave parts and a plurality of convex parts, the concave parts and the convex parts crossing each other in a matrix arrangement.

17. The diaphragm as described in claim 13, wherein the diaphragm has a substantially squared shape and comprises a continuous and winding groove.

18. The diaphragm as described in claim 13, wherein the diaphragm is formed from a metal plate using a core and a cavity by pressing.

19. The diaphragm as described in claim 18, wherein the cavity or the core has a predetermined pattern therein, the pattern being configured for forming the metal plate into the diaphragm with a continuously scraggy cross section by pressing.
